(19) United States
(12) Patent Application Publication
(10) Pub. No.: US 2026/0109112 A1
(43) Pub. Date: Apr. 23, 2026

(54) System for manufacturing a manufactured object by additive friction stir deposition and associated installation

(71) Applicant: DASSAULT AVIATION, PARIS (FR)

(72) Inventors: Joël Le Gallic, Biarritz Cedex (FR); Hugues Riotort, Biarritz Cedex (FR)

(21) Appl. No.: 19/365,169

(22) Filed: Oct. 21, 2025

(30) Foreign Application Priority Data
Oct. 22, 2024 (FR) FR 24 11478

(51) Int. Cl. B29C 64/321; B29C 64/118; B33Y 30/00; B33Y 40/00

(52) U.S. Cl. CPC B29C 64/321; B29C 64/118; B33Y 30/00; B33Y 40/00

(57) ABSTRACT

A system for manufacturing a manufactured object by additive friction stir deposition and associated installation includes a stirring device; and an effector including a feed mechanism of the drawn manufacturing material configurable in a first configuration wherein a first gripping member grips the drawn manufacturing material and moves it in a feed direction while a second gripping member releases the drawn manufacturing material and moves in a direction opposite to the feed direction, and a second configuration wherein the second gripping member grips the drawn manufacturing material and moves it in the feed direction while the first gripping member releases the drawn manufacturing material and moves in the direction opposite to the feed direction. The feed mechanism is configured to alternate between the first configuration and the second configuration.

This present disclosure relates to a system for manufacturing a manufactured object by additive friction stir deposition from a drawn manufacturing material, the drawn manufacturing material being initially wound in the form of a spool.

### BACKGROUND

Installations comprising a system of additive friction stir deposition manufacturing and a supply system for supplying the manufacturing system with manufacturing material are known from the prior art.

It is known that the supply system comprises a drum or a feeder wherein a plurality of square-section bars of manufacturing material are installed. These bars of manufacturing material are discharged one after the other from the drum or feeder to supply the manufacturing system. In such installations, the bar provided to the manufacturing system is then introduced into a stirring pin to be stirred in order to manufacture the manufactured object.

### SUMMARY

However, the use of such drums or feeders presents several disadvantages.

First, the preparation of the bars intended to be loaded into such drums or feeders is long and tedious. Indeed, each of these bars must have precise dimensions complementary to the dimensions of a chamber of the drum or feeder wherein it is intended to be inserted. In addition, their management and complex traceability require rigorous and clear marking to avoid any confusion since these bars are generally numerous and morphologically identical. Also, in the case of the use of bars, respecting the fiber directions of the cuts leading to these bars is also important and this results in significant unusable material waste.

Moreover, although the bars are of significant sections (with a surface typically greater than 9×9 mm), they have a length limited by the dimensions of the drums/feeders. Thus, these drums or feeders must be frequently reloaded with bars by a human operator. This complicates the manufacturing of the object and represents a risk for the operator.

Furthermore, the significant sections of bars lead to a stirring by a pin that is all the wider (with a diameter of about 50 mm in particular), which is penalizing for the deposition of stiffeners on aeronautical structural parts, as this then involves significant machining and additional material losses.

Also, the square cross-section of the bars reduces the homogeneity of the material addition occurring during additive manufacturing by friction stir at the exit of the stirring pin, which is generally cylindrical or conical. Indeed, the loss of load during the material creep is then not uniform before it reaches the periphery of the pin. In addition, the heat generated by friction is maximum where the distance to be traveled by the material is minimum, which increases the irregularities of the edges and possible parasitic ejections of material.

The transition between two successive bars during manufacturing presents a significant risk of introducing defects. This transition can notably lead to a lack of material during manufacturing, a non-holding of a remaining bar being consumed during the regular lifting of the stirring pin, or an inhomogeneity of the fluidity of the material added during manufacturing.

The application FR 23 07287 describes a simple, fast, and efficient installation for manufacturing a manufactured object by additive friction stir deposition, which presents fewer risks for an operator intended to interact with it and leads to the manufacturing of a superior quality object.

In particular, thanks to the use of spools of manufacturing material, the manufacturing material can be supplied to the manufacturing system continuously without requiring any cutting or operator monitoring for the supply of manufacturing material.

Moreover, with the use of spools of manufacturing material, the section of the stirred material is reduced and thus that of the stirring pin as well. This deposition width is thus much more suitable for aeronautical parts, particularly during the deposition of stiffeners or crack repairs. It also results in better temperature homogeneity during stirring.

However, it is observed that the continuous supply of manufacturing material to the manufacturing system is not sufficient to ensure flawless manufacturing. In particular, occasional insufficiencies in material addition are likely to introduce structural defects in the manufactured object. This harms the quality of the obtained manufactured object.

An aim of the present disclosure is then to provide a system for manufacturing a manufactured object by additive friction stir deposition from a drawn manufacturing material, allowing the quality of the obtained manufactured object to be improved.

To this end, the present disclosure provides a manufacturing system for manufacturing a manufactured object by additive friction stir deposition from a drawn manufacturing material comprising:
a stirring device comprising a stirring pin intended to stir the drawn manufacturing material to manufacture the manufactured object;
an effector configured to rotate the stirring pin and to supply the stirring pin with drawn manufacturing material by translating the drawn manufacturing material along a longitudinal axis of the effector in a feeding direction;
the effector comprising an actuation device including a feed mechanism for feeding the drawn manufacturing material, the feed mechanism comprising a first gripping device and a second gripping device,
the feed mechanism being configurable in:
a) a first configuration wherein at least one first gripping member of the first gripping device grips the drawn manufacturing material and moves it in the feeding direction while at least one second gripping member of the second gripping device releases the drawn manufacturing material and moves in a direction opposite to the feeding direction;
b) a second configuration wherein the at least one second gripping member grips the drawn manufacturing material and moves it in the feeding direction while the at least one first gripping member releases the drawn manufacturing material and moves in the direction opposite to the feeding direction;
the feed mechanism being intended to alternate between the first configuration and the second configuration to move the drawn manufacturing material in translation along the longitudinal axis in the feeding direction.

By means of the present disclosure, defect-free manufacturing is made possible by an uninterrupted and adjustable material addition flow at the stirring pin level. In particular, by means of the present disclosure, the effector is able to supply the stirring pin with manufacturing material to precisely fill the space corresponding to a deposition layer, the stirring being done layer by layer. This prevents the introduction of defects in the manufactured object and allows better quality parts to be obtained.

According to other advantageous aspects of the present disclosure, the manufacturing system comprises one or more of the following features, taken individually or in any technically possible combination:
the manufacturing system is such that:
the at least one first gripping member is translatable along the longitudinal axis between a first proximal coordinate and a first distal coordinate;
the at least one second gripping member is translatable along the longitudinal axis between a second proximal coordinate and a second distal coordinate;
the first proximal coordinate being located downstream of the second distal coordinate according to the feeding direction;
the at least one first and the at least one second gripping members are clamps configurable in:
clamping configuration, wherein the clamps grip the drawn manufacturing material; and
release configuration, wherein the clamps release the drawn manufacturing material;
the clamps being in:
the clamping configuration when the corresponding gripping member is moved in the feeding direction; and
the release configuration when the corresponding gripping member is moved in the direction opposite to the feeding direction;
the clamps each comprise:
a base including a cylindrical skirt, the cylindrical skirt comprising a conical internal surface defining a conical passage extending substantially along the longitudinal axis and through which the drawn manufacturing material is intended to extend;
at least two clamping elements extending at least partly in the conical passage between the conical internal surface of the cylindrical skirt and the drawn manufacturing material, each clamping element comprising a conical external surface substantially complementary to the conical internal surface of the cylindrical skirt;
a constraint element capable of constraining the at least two clamping elements against the cylindrical skirt;
each clamp being such that:
in the clamping configuration, the constraint element constrains the at least two clamping elements against the cylindrical skirt so that each clamping element is constrained against the drawn manufacturing material to grip the drawn manufacturing material;
in the release configuration, the constraint element reduces its constraint on the at least two clamping elements so that each clamping element releases the drawn manufacturing material;
the clamping elements comprise an internal surface intended to face the drawn manufacturing material and to cooperate with the drawn manufacturing material in the clamping configuration, the internal surface of each clamping element comprising teeth capable of gripping the drawn manufacturing material;
the clamping elements are angularly distributed around the longitudinal axis;
the manufacturing system is such that:
the first gripping device further includes:
a first distal flange on which the at least one first gripping member is mounted;
at least one first rack mounted on the first distal flange and extending substantially parallel to the longitudinal axis;
the second gripping device further includes:
a second distal flange on which the at least one second gripping member is mounted;
at least one second rack mounted on the second distal flange and extending substantially parallel to the longitudinal axis;
the feed mechanism further comprises at least one gear, each gear comprising teeth cooperating with teeth of the corresponding first rack and teeth of the corresponding second rack, each gear being rotatable about a rotation axis substantially perpendicular to a plane comprising the longitudinal axis;
the actuation device further comprises an actuation mechanism configurable between:
a first configuration wherein the actuation mechanism moves the at least one second rack in translation in the direction opposite to the feeding direction to simultaneously move:
the second gripping device in the direction opposite to the feeding direction;
the first gripping device in the feeding direction, by cooperation of the at least one second rack with the at least one first rack by means of the at least one gear;
a second configuration wherein the actuation mechanism moves the at least one second rack in translation in the feeding direction to simultaneously move:
the second gripping device in the feeding direction;
the first gripping device in the direction opposite to the feeding direction, by cooperation of the at least one second rack with the at least one first rack by means of the at least one gear;
the feed mechanism being:
in its first configuration when the actuation mechanism is in its first configuration;
in its second configuration when the actuation mechanism is in its second configuration;
the actuation mechanism being configured to alternate between its first and second configuration to move the drawn manufacturing material in translation along the longitudinal axis in the feeding direction.

The manufacturing system is such that:
the first gripping device further includes a first proximal flange, the at least one first rack being further mounted on the first proximal flange;
the second gripping device further includes a second proximal flange, the at least one second rack being further mounted on the second proximal flange;
the first proximal flange comprising an annular body defining an axial passage traversed by the second gripping device;
the feed mechanism comprises a support fixed in translation along the longitudinal axis, including a skirt extending substantially along the longitudinal axis, the skirt of the fixed support extending radially between the first gripping device and the second gripping device, each gear being mounted on the skirt of the fixed support;
the actuation mechanism of the actuation device is further configured to rotate the feed mechanism and the stirring pin around the longitudinal axis;
the actuation mechanism comprises:
an actuator;
a shaft extending substantially along the longitudinal axis and capable of being rotated around the longitudinal axis and translated along the longitudinal axis by the actuator;
a flange mounted on the shaft and extending substantially perpendicular to the longitudinal axis;
at least one rod designed to rotate together with the flange and extending substantially parallel to the longitudinal axis through the first gripping device, through the second gripping device, and at least partly through the stirring device;
the feed mechanism and the stirring pin being capable of being rotated around the longitudinal axis by the rotation of the at least one rod around the longitudinal axis;
the at least one second rack is mounted on the flange, the actuation mechanism being such that:
in the first configuration of the actuation mechanism, the actuator moves the at least one second rack in translation in the direction opposite to the feeding direction by moving the shaft and the flange in translation in the direction opposite to the feeding direction;
in the second configuration of the actuation mechanism, the actuator moves the at least one second rack in translation in the feeding direction by moving the shaft and the flange in translation in the feeding direction;
the actuation mechanism is configured to rotate the first and second gripping devices around the longitudinal axis, and wherein:
the drawn manufacturing material is intended to be rotated around its neutral fiber by the at least one first gripping member in the first configuration of the feed mechanism;
the drawn manufacturing material is intended to be rotated around its neutral fiber by the at least one second gripping member in the second configuration of the feed mechanism;
the effector further comprises:
an external casing delimiting an internal space wherein the feed mechanism extends;
a bearing extending between the feed mechanism and the external casing and configured to guide the feed mechanism in rotation relative to the external casing;
the effector further comprises a bearing extending between the stirring device and the external casing and configured to guide the stirring device in rotation relative to the external casing;
the effector further comprises at least one force sensor configured to measure a push force generated by the stirring pin on a substrate;
the manufacturing system further comprises a lubrication device for the bearing extending between the stirring device and the external casing;
the manufacturing system further comprises an inert gas blowing device, configured to generate an inert gas flow around the stirring pin during the stirring of the drawn manufacturing material;
the manufacturing system further comprises a cooling device for cooling down the stirring device;
the manufacturing system further comprises a cooling device for cooling down the actuation device, notably the actuation mechanism.

In addition, the present disclosure provides a manufacturing installation of a manufactured object, comprising:
a manufacturing system as described above;
a feed system configured to feed the manufacturing system with drawn manufacturing material;
the feed system being configured to rotate the drawn manufacturing material around its neutral fiber.

Optionally, the feed system comprises:
a spool of drawn manufacturing material;
a rotary unwinding device configured to unwind the drawn manufacturing material from the spool;
a guiding device for guiding the unwound drawn manufacturing material without being discharged from the rotary unwinding device to the manufacturing system,
the rotary unwinding device being configured to rotate the spool around a main rotation axis and to rotate the unwound drawn manufacturing material around its neutral fiber.

Optionally, a difference between the rotation speed of the spool generated by the feed system of the manufacturing installation and the rotation speed of the drawn manufacturing material generated by the effector is between 0.5 rpm and 5 rpm when the drawn manufacturing material is stirred by the manufacturing system.

### BRIEF DESCRIPTION OF THE DRAWINGS

The present disclosure will be better understood upon reading the following description, given solely by way of non-limiting example, and made with reference to the drawings wherein:

FIG. 1 is a top perspective view of a manufacturing installation according to the present disclosure;

FIG. 2 is a top perspective view of a manufacturing system of the manufacturing installation shown in FIG. 1, according to a first embodiment of the present disclosure;

FIG. 3 is a sectional view of the manufacturing system shown in FIG. 2, according to a sectional plane III-III comprising the longitudinal axis of the effector;

FIG. 4 Is an Enlarged Illustration of a Part Iv of FIG. 3;

FIG. 5 is a sectional view of the manufacturing system shown in FIG. 2, according to a sectional plane V-V substantially perpendicular to the longitudinal axis of the effector;

FIG. 6 is a perspective view of a gripping member of a gripping device of the manufacturing system shown in FIG. 2, wherein the clamping elements of said gripping member are axially offset away from the conical passage of said gripping member in an exaggerated manner;

FIG. 7 is a simplified schematic illustration of a portion of a manufacturing system of the manufacturing installation shown in FIG. 1, according to a second embodiment of the present disclosure.

### DETAILED DESCRIPTION

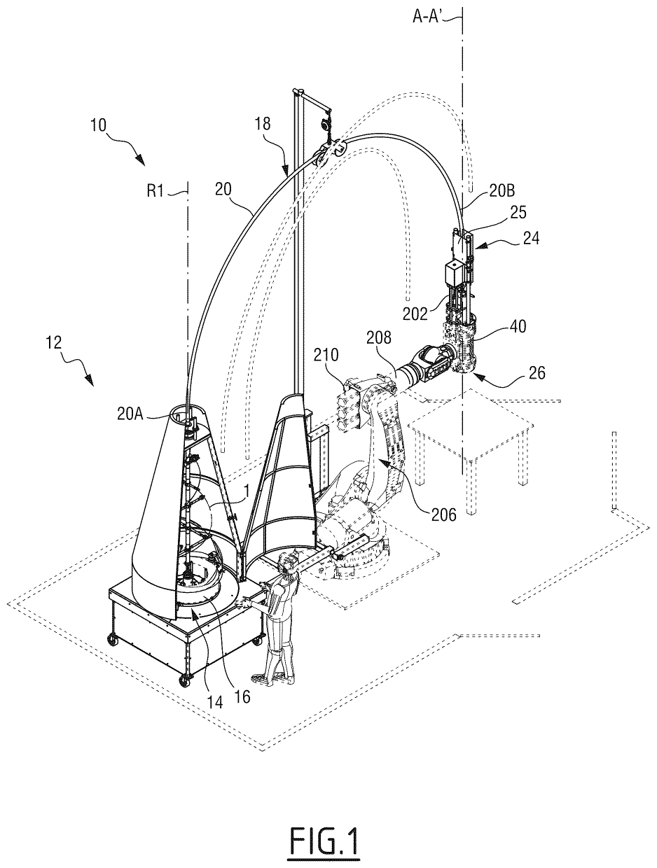

Referring to FIGS. 1 to 7, a manufacturing installation 10 for an object manufactured by additive friction stir deposition from a drawn manufacturing material 1 is described.

The manufacturing installation 10 comprises a manufacturing system 24 according to the present disclosure and a feed system 12 configured to feed the manufacturing system 24 with drawn manufacturing material 1.

Advantageously, the manufacturing installation 10 further comprises a robot 206 configured to manipulate the manufacturing system 24.

The feed system 12 is configured to rotate the drawn manufacturing material 1 around its neutral fiber.

Advantageously, the feed system 12 is further configured to translate the drawn manufacturing material 1, notably following a traction exerted by a feed mechanism 44 of an effector 40 of the manufacturing system 24.

In particular, the feed system 12 is the one described in application FR 23 07287, wherein the manufacturing material wire corresponds to the drawn manufacturing material 1 in the present application. For example, the drawn manufacturing material 1 has a diameter between 3 mm and 5 mm.

The feed system 12 notably comprises a spool 16 of drawn manufacturing material, a rotary unwinding device 14 configured to unwind the drawn manufacturing material 1 from the spool 16, and a device 18 for guiding the unwound drawn manufacturing material from the rotary unwinding device 14 to the manufacturing system 24.

In particular, the rotary unwinding device 14 is configured to rotate the spool 16 around a main rotation axis R1 and to rotate the unwound drawn manufacturing material 1 around its neutral fiber.

The feed system 12, in particular the rotary unwinding device 14, is notably configured to rotate the spool 16 with an additional rotation speed corresponding tangentially at the spool 16 exit, to the amount of material required by the effector 40, thanks to a traction effort exerted on the drawn manufacturing material 1 by at least one gripping member described below.

Advantageously, the guiding device 18 for the unwound drawn manufacturing material comprises a guiding sheath 20 extending from a proximal end 20A connected to the rotary unwinding device 14 to a distal end 20B connected to the manufacturing system 24, optionally comprising a rotary straightener 25 for the drawn manufacturing material 1, optionally represented only in FIG. 1.

Advantageously, the translation generated by the feed system 12 corresponds to the slight additional rotation of the spool 16 compared to that of the effector 40, as explained in application FR 23 07287. Advantageously, this additional rotation does not result in a phase shift between the rotation speed of the drawn manufacturing material 1 at the exit of the feed system 12 and the rotation speed of the drawn manufacturing material 1 in the effector 40.

In particular, a difference between the rotation speed of the spool 16 generated by the feed system 12 and the rotation speed of the drawn manufacturing material 1 generated by the effector 40 of the manufacturing system 24 is between 0.5 rpm and 5 rpm when the drawn manufacturing material 1 is stirred by the manufacturing system 24 (corresponding notably to an advance of the drawn manufacturing material 1 at a speed between 500 mm/min and 5,000 mm/min) and advantageously substantially equal to 0 rpm when the drawn manufacturing material 1 is fed to the manufacturing system 24 without the drawn manufacturing material 1 being stirred.

Referring to FIGS. 1 to 6, a first embodiment of a manufacturing system 24 is described.

The system 24 is a manufacturing system for manufacturing the manufactured object by additive friction stir deposition from the drawn manufacturing material 1.

The manufacturing system 24 comprises a stirring device 26 and an effector 40.

Advantageously, the manufacturing system 24 further comprises a lubrication device 158.

Advantageously, the manufacturing system 24 further comprises an inert gas blowing device 166.

Advantageously, the manufacturing system 24 further comprises a cooling device 172 for cooling down the stirring device 26.

Advantageously, the manufacturing system 24 further comprises a cooling device 184 for cooling down an actuation device 124, notably an actuation mechanism 126 of the actuation device 124, of the effector 40.

Advantageously, the manufacturing system 24 comprises a guiding device 192 for guiding the effector 40 and the stirring device 26.

The stirring device 26 comprises a stirring pin 28 intended to stir the drawn manufacturing material 1 to manufacture the manufactured object.

The stirring device 26 is notably mounted on a distal end of the effector 40.

Advantageously, the stirring pin 28 is configured to be rotated by the effector 40 around the longitudinal axis A-A′ of the effector 40 and is intended to stir the drawn manufacturing material 1 to manufacture the manufactured object. In particular, the stirring of the unwound drawn manufacturing material 1 makes the manufacturing material malleable to add this malleable material to a substrate to gradually manufacture the manufactured object.

Advantageously, the stirring pin 28 is rotated around the longitudinal axis A-A′ by the rotation of at least one rod 136 of the actuation mechanism 126, which will be described below.

Advantageously, the stirring pin 28 has a diameter, measured in a direction substantially perpendicular to the longitudinal axis A-A′, between 15 mm and 30 mm.

For example, the stirring device 26 comprises a support 30 on which the stirring pin 28 is mounted.

Advantageously, the support 30 comprises a generally cylindrical body with a longitudinal axis A-A′. The support 30 is notably mounted on the effector 40.

The support 30 notably comprises a cavity 32 for receiving the stirring pin 28, the cavity 32 extending along the longitudinal axis A-A′ from a distal face 30A of the support 30.

Notably, the support 30 is configured to be rotated by the effector 40, in particular by the actuation mechanism 126, around the longitudinal axis A-A′ of the effector 40. The rotation of the support 30 drives the rotation of the stirring pin 28 around the longitudinal axis A-A′.

The support 30 of the stirring device 26 notably comprises an axial passage 34 extending substantially along the longitudinal axis A-A′ and through which the drawn manufacturing material 1 is intended to circulate towards the stirring pin 28.

The support 30 further comprises, for example, a cavity 36 for receiving the at least one rod 136 of the actuation mechanism 126 of the effector 40, which will be described below.

The effector 40 is configured to rotate the stirring pin 28 and to supply the stirring pin 28 with drawn manufacturing material 1 by translating the drawn manufacturing material 1 along the longitudinal axis A-A′ in a feeding direction DA.

In particular, the effector 40 is further configured to rotate the drawn manufacturing material 1 around the longitudinal axis A-A′, which is notably substantially coincident with the neutral fiber of the drawn manufacturing material 1 extending in the effector 40.

Notably, the effector 40 defines a path 42 for conveying the drawn manufacturing material 1 wherein the drawn manufacturing material 1 is intended to be conveyed towards the stirring device 26.

Advantageously, the conveying path 42 of the effector 40 extends along the longitudinal axis A-A′.

The conveying path 42 of the effector 40 is particularly delimited by a plurality of elements of the effector 40 described below, notably passages 132, 50, 88.

The conveying path 42 of the effector 40 notably extends from an axial entry 42A to which the drawn manufacturing material 1 is supplied by the feed system 12 and an axial exit 42B facing the stirring device 26, notably facing the axial passage 34 of the support 30 of the stirring device 26, from which the drawn manufacturing material 1 is supplied to the stirring device 26, particularly to the stirring pin 28, to be stirred.

The effector 40 comprises the actuation device 124 configured to rotate the feed mechanism 44 and the stirring device 26 around the longitudinal axis A-A′.

Advantageously, the effector 40 comprises an external casing 140, a first bearing 146, and a second bearing 152.

Advantageously, the effector 40 comprises at least one force sensor 156.

The actuation device 124 comprises the feed mechanism 44 of the drawn manufacturing material 1.

Advantageously, the actuation device 124 further comprises the actuation mechanism 126.

The feed mechanism 44 comprises a first gripping device 60 and a second gripping device 100.

Advantageously, in the first embodiment, the feed mechanism 44 comprises at least one gear 120. In particular, the feed mechanism 44 comprises as many gears 120 as first racks 78 or second racks 112 described below.

Advantageously, the feed mechanism 44 comprises a support 46.

The feed mechanism 44 is configurable in:
a) a first configuration wherein at least one first gripping member 80 of the first gripping device 60 grips the drawn manufacturing material 1 and moves it in the feeding direction DA while at least one second gripping member 116 of the second gripping device 100 releases the drawn manufacturing material and moves in a direction DB opposite to the feeding direction DA;
b) a second configuration wherein the at least one second gripping member 116 grips the drawn manufacturing material 1 and moves it in the feeding direction DA while the at least one first gripping member 80 releases the drawn manufacturing material 1 and moves in the direction DB opposite to the feeding direction DA.

The feed mechanism 44 is intended to alternate between the first configuration and the second configuration to move the drawn manufacturing material 1 in translation along the longitudinal axis A-A′ in the feeding direction DA. Notably, when the at least one first gripping member 80 grips the drawn manufacturing material 1, the at least one second gripping member 116 releases the drawn manufacturing material 1 simultaneously, and when the at least one first gripping member 80 releases the drawn manufacturing material 1, the at least one second gripping member 116 grips the drawn manufacturing material 1 simultaneously. The quasi-instantaneous alternation between the first configuration and the second configuration allows the drawn manufacturing material 1 to be moved in translation almost without interruption. Notably, by “without interruption,” we mean that the drawn manufacturing material 1 is moved in translation without the corresponding translation speed being substantially zero for more than 0.1 s.

For example, the feed mechanism 44 is configured to move the drawn manufacturing material 1 in translation along the longitudinal axis A-A′ in the feeding direction DA at a speed between 500 mm/min and 5,000 mm/min.

Advantageously, the feed mechanism 44 is further intended to be rotated around the longitudinal axis A-A′ by the rotation of the at least one rod 136 of the actuation mechanism 126 around the longitudinal axis A-A′, notably at a rotation speed between 100 and 5,000 rpm.

The support 46 of the feed mechanism 44 is fixed in translation along the longitudinal axis A-A′ and notably mobile in rotation around the longitudinal axis A-A′.

The support 46 comprises a base 48 extending substantially perpendicular to the longitudinal axis A-A′ and a skirt 56 extending substantially along the longitudinal axis A-A′ from the base 48.

The base 48 of the support 46 of the feed mechanism 44 extends between flanges 102, 110 of the second gripping device 100, which will be described below.

Advantageously, the base 48 defines an axial passage 50 extending along the longitudinal axis A-A′ and through which the drawn manufacturing material 1 is intended to extend. The axial passage 50 of the base 48 at least partly defines the conveying path 42 of the effector 40.

Advantageously, the base 48 defines at least one through-hole 52 through which a rack 112 of the second gripping device 100 extends.

Advantageously, the base 48 defines at least one cavity 54 for receiving the at least one rod 136 of the actuation mechanism 126.

The skirt 56 of the support 46 extends radially between the first gripping device 60 and the second gripping device 100.

The skirt 56 notably comprises axial notches 58 extending longitudinally from a distal edge 56A of the skirt 56. The axial notches 58 receive the gears 120.

The Skirt 56 Is Notably Fixed in Translation Along the Longitudinal Axis A-A′.

The first gripping device 60 comprises the at least one first gripping member 80. In the example of the figures, the first gripping device 60 comprises a single first gripping member 80. In a non-illustrated variant, the first gripping device 60 comprises a plurality of first gripping members 80.

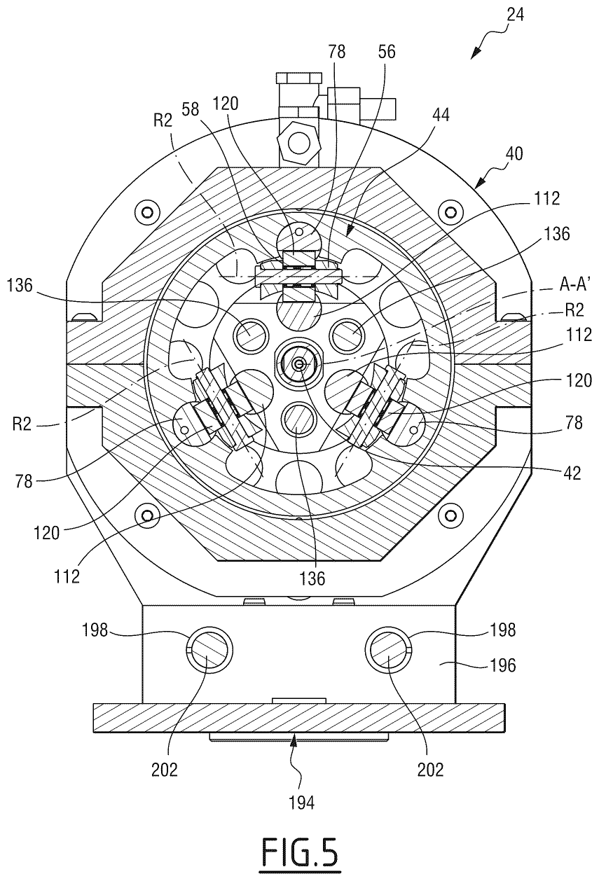

Advantageously, the first gripping device 60 further comprises a first distal flange 62 and at least one first rack 78. For example, as illustrated in FIG. 5, the first gripping device 60 comprises a plurality of first racks 78 angularly distributed around the longitudinal axis A-A′, notably at least two first racks 78, in particular at least three first racks 78 as illustrated in the figures.

Advantageously, the first gripping device 60 further comprises a first proximal flange 70.

For example, the first distal flange 62 extends in a plane substantially perpendicular to the longitudinal axis A-A′.

Advantageously, the first distal flange 62 comprises an axial hole 64 wherein the at least one first gripping member 80 is mounted.

Advantageously, the first distal flange 62 comprises at least one cavity 66 for receiving the at least one first rack 78.

Advantageously, the first distal flange 62 comprises at least one through-hole 68 through which the at least one rod 136 of the actuation mechanism 126 of the effector 40 extends.

For example, the first proximal flange 70 extends in a plane substantially perpendicular to the longitudinal axis A-A′, in particular substantially parallel to the first distal flange 62.

Advantageously, the first proximal flange 70 comprises an annular body 72 defining an axial passage 74 through which the second gripping device 100 extends, and notably also the at least one rod 136 of the actuation mechanism 126 of the effector 40.

Advantageously, the first proximal flange 70 further comprises at least one cavity 76 for receiving the at least one first rack 78.

The first proximal flange 70 allows the plurality of angularly distributed racks 78 to be secured.

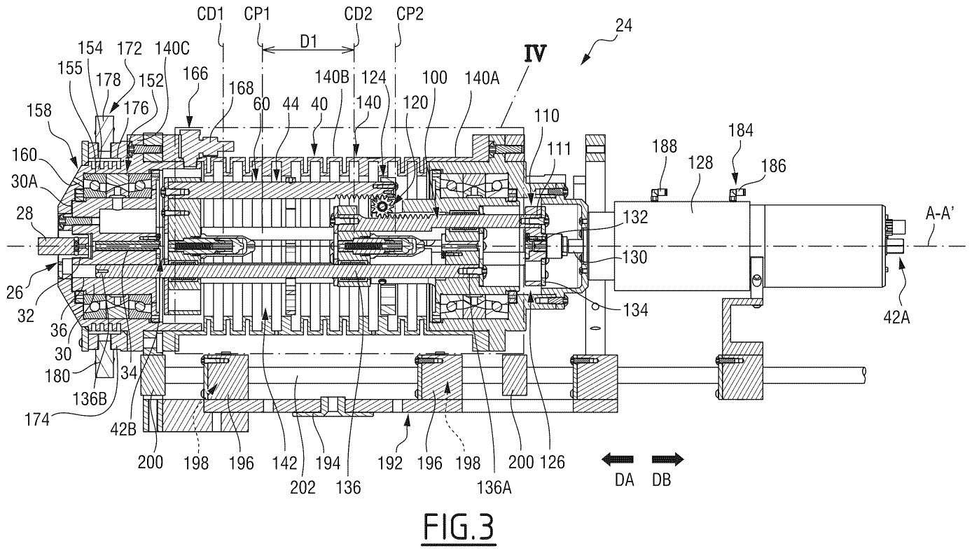

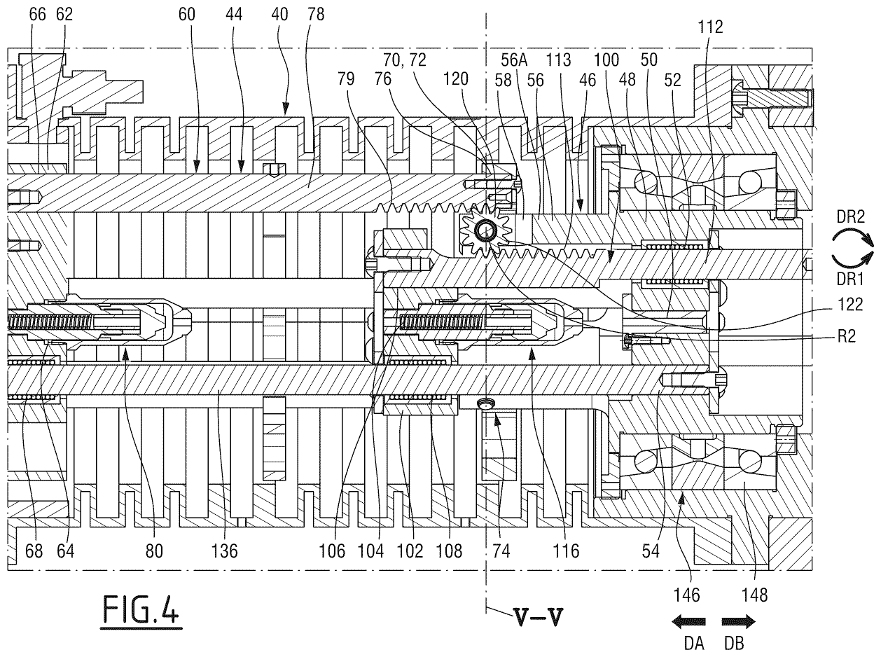

Referring to FIGS. 3 and 4, the at least one first rack 78 is mounted on the first distal flange 62, notably in the receiving cavity 66, and extends substantially parallel to the longitudinal axis A-A′.

In particular, the at least one first rack 78 is further mounted on the first proximal flange 70, notably in the receiving cavity 76.

The at least one first gripping member 80 extends along the longitudinal axis A-A′. In the case where the first gripping device 60 comprises a plurality of first gripping members 80, the first gripping members 80 are aligned along the longitudinal axis A-A′.

Advantageously, the at least one first gripping member 80 is translatable between a first proximal coordinate CP1 and a first distal coordinate CD1 along the longitudinal axis A-A′.

Advantageously, the at least one first gripping member 80 is mounted on the first distal flange 62.

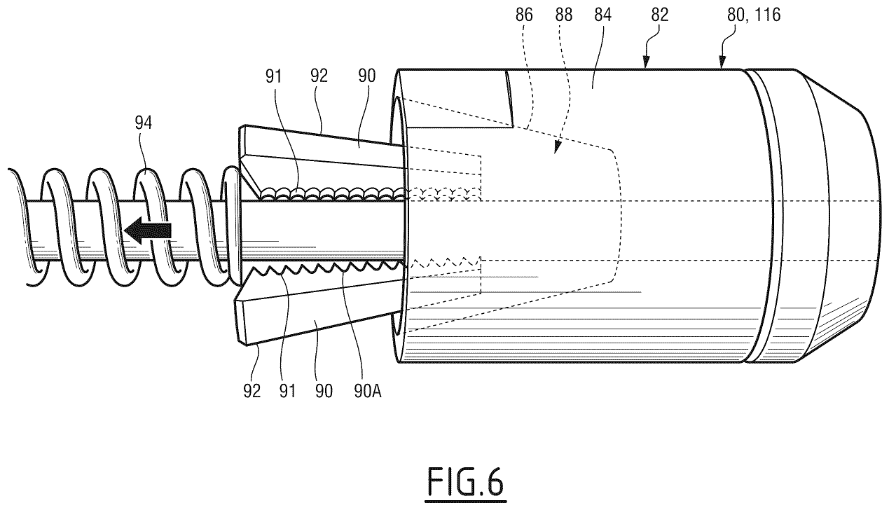

For example, referring to FIG. 6, the at least one first gripping member 80 is a first clamp configurable between:
a clamping configuration, wherein the first clamp grips the drawn manufacturing material; and
a release configuration, wherein the first clamp releases the drawn manufacturing material.

Notably, the first clamp is in:
the clamping configuration when the corresponding first gripping member 80 is moved in the feeding direction DA; and
the release configuration when the corresponding first gripping member 80 is moved in the direction DB.

Advantageously, referring to FIG. 6, the first clamp comprises a base 82, at least two clamping elements 90, and a constraint element 94.

The base 82 includes an external cylindrical skirt 84.

The cylindrical skirt 84 comprises a conical internal surface 86 defining a conical passage 88 extending substantially along the longitudinal axis A-A′ and through which the drawn manufacturing material 1 is intended to extend.

The at least two clamping elements 90 are intended to extend at least partly in the conical passage 88 between the conical internal surface 86 of the cylindrical skirt 84 and the drawn manufacturing material 1.

Each clamping element 90 comprises a conical external surface 92 substantially complementary to the conical internal surface 86 of the cylindrical skirt 84.

The constraint element 94 is capable of constraining the at least two clamping elements 90 against the cylindrical skirt 84. The constraint element 94 is, for example, a spring intended to extend around the drawn manufacturing material 1 parallel to the longitudinal axis A-A'. The spring is notably, on the one hand, axially supported on the clamping elements 90 and, on the other hand, supported on the flange on which the gripping member is mounted.

In particular, when the constraint element 84 constrains the at least two clamping elements 90 against the cylindrical skirt 84, the conical external surface 92 of the clamping elements 90 undergoes a radial constraint directed substantially towards the longitudinal axis A-A′ by cooperation of the conical external surface 92 with the conical internal surface 86 of the cylindrical skirt 84.

The first clamp is such that:
in the clamping configuration, the constraint element 94 constrains the at least two clamping elements 90 against the cylindrical skirt 84 so that each clamping element 90 is constrained against the drawn manufacturing material 1 to grip the drawn manufacturing material 1;
in the release configuration, the constraint element 94 reduces its constraint on the at least two clamping elements 90 so that each clamping element 90 releases the drawn manufacturing material 1.

Advantageously, in the first configuration of the feed mechanism 44, the at least one first gripping member 80 is intended to rotate the drawn manufacturing material 1 around its neutral fiber. In particular, the rotation of the at least one first gripping member 80 around the longitudinal axis A-A′ and the gripping of the drawn manufacturing material 1 by the at least one first gripping member 80 rotates the drawn manufacturing material 1 around its neutral fiber, which is notably intended to be substantially coincident with the longitudinal axis A-A′.

Advantageously, in the second configuration of the feed mechanism 44, the at least one second gripping member 116 is intended to rotate the drawn manufacturing material 1 around its neutral fiber. In particular, the rotation of the at least one second gripping member 116 around the longitudinal axis A-A′ and the gripping of the drawn manufacturing material 1 by the at least one second gripping member 116 rotates the drawn manufacturing material 1 around its neutral fiber.

For example, the feed mechanism 44 is configured so that each first clamp is in the clamping configuration when the at least one first gripping member 80 is moved in the feeding direction DA and so that each first clamp is in the release configuration when the at least one first gripping member 80 is moved in the direction DB.

The second gripping device 100 comprises the at least one second gripping member 116. In the example of the figures, the second gripping device 100 comprises a single second gripping member 116. In a non-illustrated variant, the second gripping device 100 comprises a plurality of second gripping members 116.

Advantageously, referring to FIGS. 3 to 5, the second gripping device 100 further comprises a second distal flange 102 and at least one second rack 112. For example, referring to FIG. 5, the second gripping device 100 comprises a plurality of second racks 112 angularly distributed around the longitudinal axis A-A′, notably at least two second racks 112, in particular at least three second racks as illustrated in the example of the figures. In particular, the second gripping device 100 and the first gripping device 60 each comprise the same number of racks 112, 78.

Advantageously, the second gripping device 100 further comprises a second proximal flange 110.

For example, the second distal flange 102 extends in a plane substantially perpendicular to the longitudinal axis A-A′.

Advantageously, the second distal flange 102 comprises an axial hole 104 wherein the second gripping member 116 is mounted.

Advantageously, the second distal flange 102 comprises at least one cavity 106 for receiving the at least one second rack 112.

Advantageously, the second distal flange 102 comprises at least one through-hole 108 through which the at least one rod 136 of the actuation mechanism 126 of the effector 40 extends.

For example, the second proximal flange 110 extends in a plane substantially perpendicular to the longitudinal axis A-A′, in particular substantially parallel to the second distal flange 102.

The at least one second rack 112 is mounted on the second distal flange 102, notably in the receiving cavity 106, and extends substantially parallel to the longitudinal axis A-A′.

In particular, the at least one second rack 112 is further mounted on the second proximal flange 110, notably in a receiving cavity 111 of the second proximal flange 110.

Advantageously, referring to FIG. 4, the at least one second rack 112 extends at least partly facing the at least one first rack 78, notably so that teeth 113 of the at least one second rack 112 face teeth 79 of the at least one first rack 78. Advantageously, still referring to FIG. 4, the at least one gear 120 extends between the at least one second rack 112 and the at least one first rack 78.

The at least one second gripping member 116 extends along the longitudinal axis A-A′. In the case where the second gripping device 100 comprises a plurality of second gripping members 116, the second gripping members 116 are aligned along the longitudinal axis A-A′.

Advantageously, the at least one second gripping member 116 is translatable between a second proximal coordinate CP2 and a second distal coordinate CD2 along the longitudinal axis A-A′.

In particular, the at least one second gripping member 116 and the at least one first gripping member 80 are intended to move symmetrically relative to a plane substantially perpendicular to the longitudinal axis A-A′, said plane notably extending between the second distal coordinate CD2 and the first proximal coordinate CP1.

Advantageously, the at least one second gripping member 116 is mounted on the second distal flange 102.

For example, the first proximal coordinate CP1 is located downstream of the second distal coordinate CD2 according to the feeding direction DA. Thus, the stroke of the at least one first gripping member 80 is located downstream of the stroke of the at least one second gripping member 116.

Advantageously, the distance D1 between the first proximal coordinate CP1 and the second distal coordinate CD2, measured along the longitudinal axis A-A′, is between 10 mm and 150 mm. When the first gripping device 60 includes a plurality of first gripping members 80 and when the second gripping device 100 includes a plurality of second gripping members 116, the distance D1 is measured between the closest first and second gripping members 80, 116. This prevents the risk of the drawn manufacturing material 1 buckling when the spacing between the gripping members is maximal and when it is symmetrically reduced.

For example, the at least one second gripping member 116 is a second clamp configurable between:
a clamping configuration, wherein the second clamp grips the drawn manufacturing material; and
a release configuration, wherein the second clamp releases the drawn manufacturing material.

Notably, the second clamp is in:
the clamping configuration when the at least one second gripping member 116 is moved in the feeding direction DA; and
the release configuration when the at least one second gripping member 116 is moved in the direction DB.

Advantageously, referring to FIG. 6, the second clamp is structurally identical to the first clamp.

The second clamp is such that:
in the clamping configuration, the constraint element 94 constrains the at least two clamping elements 90 against the cylindrical skirt 84 so that each clamping element 90 is constrained against the drawn manufacturing material 1 to grip the drawn manufacturing material 1;
in the release configuration, the constraint element 94 reduces its constraint on the at least two clamping elements 90 so that each clamping element 90 releases the drawn manufacturing material 1.

Advantageously, the clamping elements 90 of the clamps of the at least one first and at least one second gripping members 80, 116 comprise an internal surface 90A facing the axis A-A′ and thus intended to face the drawn manufacturing material 1.

The internal surface 90A of the clamping elements 90 is further intended to cooperate with the drawn manufacturing material 1 in the clamping configuration, notably to grip the drawn manufacturing material 1 in the clamping configuration.

Notably, the internal surface 90A of the clamping elements 90 comprises teeth 91 capable of gripping the drawn manufacturing material 1. Thus, each gripping member 80, 116 effectively grips the drawn manufacturing material 1 to move it along the longitudinal axis A-A′ and to rotate it by the action of the actuation mechanism 126, as will be presented in more detail below.

Advantageously, for each clamp, the gripping force of the drawn manufacturing material 1 generated by the clamping elements 90 is such that in case of a substantial difference between the rotation speed generated by the actuation mechanism 126 and the rotation speed of the drawn manufacturing material 1 generated by the feed system 12, the drawn manufacturing material 1 is released in rotation around its neutral fiber. The possible striations marked by the teeth 91 of the clamping elements 90 do not prevent the progression of the drawn manufacturing material 1 in the feeding direction DA. On the contrary, when the teeth 91 penetrate the striations, this improves the grip of the drawn manufacturing material 1 by the clamping elements 90.

Advantageously, the teeth 91 are configured so that they grip the drawn manufacturing material 1 when the teeth 91 move in the feeding direction DA relative to the drawn manufacturing material 1 and so that they release the drawn manufacturing material 1 when the teeth 91 move in the opposite direction DB. Advantageously, the clamps are configured to allow the evacuation of waste (for example, manufacturing material chips) generated by the action of the teeth 91 on the drawn manufacturing material 1.

Advantageously, in case of a difference between the rotation speed generated by the actuation mechanism 126 and the rotation speed of the drawn manufacturing material 1 generated by the feed system 12, the gripping members 80, 116, in particular the corresponding clamping elements 90, generate a torsion on the drawn manufacturing material 1, said torsion causing a straightening of the drawn manufacturing material 1, which, as a reminder, is notably initially stored in the form of a spool 16 from which the drawn manufacturing material 1 exits with a more or less pronounced curvature.

Advantageously, referring to FIG. 6, the clamping elements 90 of the clamps of the first and second gripping members 80, 116 are angularly distributed around the longitudinal axis A-A′.

For example, the feed mechanism 44 is configured so that each second clamp is in the clamping configuration when the at least one second gripping member 116 is moved in the feeding direction DA and so that each second clamp is in the release configuration when the at least one second gripping member 116 is moved in the direction DB.

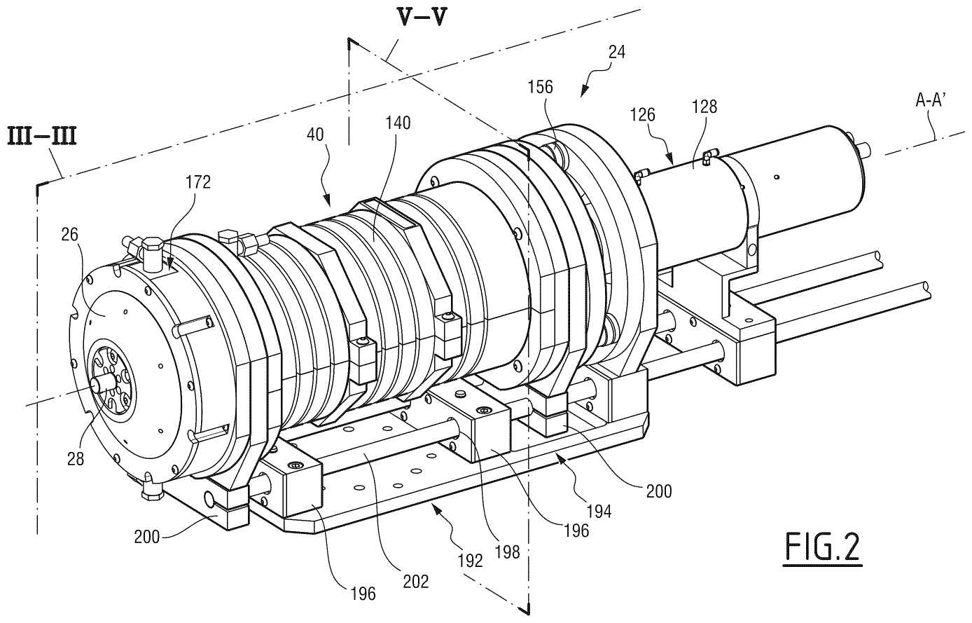

Referring to FIGS. 2 to 5, each gear 120 is mounted on the skirt 56 of the support 46 of the feed mechanism 44. In particular, each gear 120 is mounted in an axial notch 58 of the skirt 56 (visible in FIG. 4).

Notably, each gear 120 is fixed in translation along the longitudinal axis A-A′.

Each gear 120 comprises teeth 122 intended to cooperate with teeth 79 of the corresponding first rack 78 and teeth 113 of the corresponding second rack 112. In particular, the teeth 122 of each gear 120 are engaged with the teeth 79 of the corresponding first rack 78 and the teeth 113 of the corresponding second rack 112.

Each gear 120 is rotatable about an axis R2 substantially perpendicular to a plane comprising the longitudinal axis A-A′ in a first rotation direction DR1 and in a second rotation direction DR2 opposite to the first rotation direction DR1 (see FIG. 4).

The actuation mechanism 126 is configurable between:
a first configuration wherein the actuation mechanism 126 moves the at least one second rack 112 in translation in the direction DB opposite to the feeding direction DA to simultaneously move:
the second gripping device 100 in the direction DB opposite to the feeding direction DA;
the first gripping device 60 in the feeding direction DA, by cooperation of the at least one second rack 112 with the at least one first rack 78 by means of the at least one gear 120;
a second configuration wherein the actuation mechanism 126 moves the at least one second rack 112 in translation in the feeding direction DA to simultaneously move:
the second gripping device 100 in the feeding direction DA;
the first gripping device 60 in the direction DB opposite to the feeding direction DA, by cooperation of the at least one second rack 112 with the at least one first rack 78 by means of the at least one gear 120.

In particular:
in the first configuration of the actuation mechanism 126, the at least one second rack 112 is translated in the direction DB opposite to the feeding direction DA, which rotates the at least one gear 120 in the first rotation direction DR1, which translates the at least one first rack 78 in the feeding direction DA.
in the second configuration of the actuation mechanism 126, the at least one second rack 112 is translated in the feeding direction DA, which rotates the at least one gear 120 in the second rotation direction DR2, which translates the at least one first rack 78 in the direction DB.

The feed mechanism 44 is:
in its first configuration when the actuation mechanism 126 is in its first configuration;
in its second configuration when the actuation mechanism 126 is in its second configuration.

The actuation mechanism 126 being configured to alternate between its first and second configuration to move the drawn manufacturing material 1 in translation along the longitudinal axis A-A′ in the feeding direction DA.

The actuation mechanism 126 is further configured to rotate the feed mechanism 44 and the stirring pin 28 around the longitudinal axis A-A′.

In particular, the actuation mechanism 126 is configured to rotate the first and second gripping devices 60, 100, notably the first and second gripping members 80, 116 around the longitudinal axis A-A′. The actuation mechanism 126 is further configured to rotate the support 46 of the feed mechanism 44 on which the at least one gear 120 and the at least one second rack 112 are mounted around the longitudinal axis A-A′.

The actuation mechanism 126 comprises an actuator 128, a shaft 130, a flange 134, and at least one rod 136. For example, referring to FIG. 5, the actuation mechanism 126 comprises a plurality of rods 136 angularly distributed around the longitudinal axis A-A′, for example at least two rods 136, notably at least three rods 136 as illustrated in the example of the figures.

Advantageously, the installation 10 further comprises a synchronization device (not illustrated) configured to adapt the rotation speed of the drawn manufacturing material 1 generated by the feed system 12 to be in phase with the rotation speed generated by the actuation mechanism 126, in particular so that the difference between the rotation speed generated by the actuation mechanism 126 and the rotation speed of the spool 16 generated by the feed system 12 only comes from the consumption of drawn manufacturing material 1 at the spool 16 level. In addition, the synchronization device is configured to adapt the alternation frequency between the first and second configuration of the actuation mechanism 126. Notably, the synchronization device is configured to control the actuator 128 to modify the speed and direction of translation of the at least one second rack 112 along the longitudinal axis A-A′, in particular to adapt the amount of manufacturing material supplied to the stirring pin 28. The translation stroke is initially adjusted to best correspond to the buckling resistance capabilities of the drawn manufacturing material 1 and the toothed lengths of the racks.

The actuator 128 comprises, for example, a first motor configured to rotate the shaft 130 around the longitudinal axis A-A′ and a second motor configured to translate the shaft 130 along the longitudinal axis A-A′. In a variant, the actuator 128 comprises a single motor configured to rotate the shaft 130 around the longitudinal axis A-A′, said motor being mounted on a jack configured to translate said motor and the shaft 130 along the longitudinal axis A-A′.

The shaft 130 extends substantially along the longitudinal axis A-A′ and is capable of being rotated around the longitudinal axis A-A′ and translated along the longitudinal axis A-A′ by the actuator 128.

The shaft 130 comprises a tubular passage 132 extending substantially along the longitudinal axis A-A′ and through which the drawn manufacturing material 1 is intended to extend. The tubular passage 132 of the shaft 130 forms at least partly the conveying path 42 of the effector 40.

The flange 134 is mounted on the shaft 130 and extends substantially perpendicular to the longitudinal axis A-A′.

The flange 134 is notably rotated by the shaft 130.

Referring to FIG. 3, the flange 134 is notably coincident with the second proximal flange 110 of the second gripping device 100.

Advantageously, the at least one second rack 112 is mounted on the flange 134, the actuation mechanism 126 being such that:
in the first configuration of the actuation mechanism 126, the actuator 128 moves the at least one second rack 112 in translation in the direction DB opposite to the feeding direction DA by translating the shaft 130 and the flange 134 in translation in the direction DB opposite to the feeding direction DA;
in the second configuration of the actuation mechanism 126, the actuator 128 moves the at least one second rack 112 in translation in the feeding direction DA by translating the shaft 130 and the flange 134 in translation in the feeding direction DA.

The at least one rod 136 is designed to rotate together with the flange 134, notably by means of the support 46. In a non-illustrated variant, the at least one rod 136 is mounted on the flange 134.

The at least one rod 136 extends substantially parallel to the longitudinal axis A-A′ through the first gripping device 60, through the second gripping device 100, and at least partly through the stirring device 26.

In particular, the at least one rod 136:
is received in the receiving cavity 36 of the support 30 of the stirring device 26;
extends through the at least one through-hole 68 of the first distal flange 62 of the first gripping device 60;
extends through the at least one through-hole 108 of the second distal flange 102 of the second gripping device 100; and -is received in the receiving cavity 54 of the support 46 of the feed mechanism 44.

Notably, a distal end 136B of the at least one rod 136 is received in the receiving cavity 36 of the support 30 of the stirring device 26, and a proximal end 136A of the at least one rod 136, opposite the distal end 136B, is received in the receiving cavity 54 of the support 46 of the feed mechanism 44.

The at least one rod 136 is rotated around the longitudinal axis A-A′.

In particular, the feed mechanism 44 is rotated around the longitudinal axis A-A′ by the rotation of the at least one rod 136 around the longitudinal axis A-A′.

The external casing 140 defines an internal space 142 wherein the feed mechanism 44 extends, and advantageously also the stirring device 26.

In particular, the external casing 140 comprises a distal portion 140C, a proximal portion 140A, and an intermediate portion 140B extending between the distal portion 140C and the proximal portion 140A.

The distal portion 140C of the external casing 140 extends around the stirring device 26.

The intermediate portion 140B of the external casing 140 extends around the feed mechanism 44, notably around the first and second gripping devices 60, 100.

The proximal portion 140A of the external casing 140 extends around the support 46 of the feed mechanism 44.

The bearing 146 extends between the feed mechanism 44 and the external casing 140 and is configured to guide the feed mechanism 44 in rotation around the longitudinal axis A-A′ relative to the external casing 140.

In particular, the bearing 146 extends between the support 46 of the feed mechanism 44 and the external casing 140, notably the proximal portion 140A of the external casing 140.

The bearing 146 notably comprises at least one bearing 148, in particular a ball or roller bearing.

The bearing 152 extends between the stirring device 26 and the external casing 140 and is configured to guide the stirring device 26 in rotation around the axis A-A′ relative to the external casing 140.

In particular, the bearing 152 extends between the support 30 of the stirring device 26 and the external casing 140, notably the distal portion 140C of the external casing 140.

The bearing 152 notably comprises at least one bearing 154, in particular a ball or roller bearing.

Notably, the bearing 154 is an angular contact bearing and is configured to take up the axial force generated by the stirring pin 28 on the substrate.

The lubrication device 158 is configured to lubricate the bearing 152 extending between the stirring device 26 and the external casing 140.

The lubrication device 158 notably comprises a lubricant inlet 160 and a lubricant outlet (not illustrated) advantageously connected to a suction device in fluid communication with a rolling path 155 of the bearing 154.

The lubrication device 158 further comprises, for example, a lubricant source (not illustrated) intended to supply lubricant to the lubricant inlet 160.

The inert gas blowing device 166 is configured to generate an inert gas flow around the stirring pin 28 of the stirring device 26 during the stirring of the drawn manufacturing material 1.

In particular, the inert gas blowing device 166 comprises a gas inlet 168 in fluid communication with the internal space 142 delimited by the casing 140.

The inert gas blowing device 166 further comprises an inert gas source (not illustrated) intended to supply inert gas to the gas inlet 168.

The cooling device 172 for the stirring device 26 comprises a crown 174 extending around the external casing 140, in particular around the distal portion 140C of the external casing 140.

The crown 174 defines with the external casing 140, notably with the distal portion 140C of the external casing 140, an annular space 178 for circulating a cooling fluid.

The cooling device 172 further comprises a fluid inlet 178 and a fluid outlet 180 in fluid communication with the annular space 176.

The cooling device 172 further comprises a cooling fluid source (not illustrated) intended to supply the fluid inlet 178 with cooling fluid.

The cooling device 184 for the actuation device 124 is notably a cooling device for the actuator 128 of the actuation mechanism 126.

The cooling device 184 comprises a fluid inlet 186 and a fluid outlet 188 in fluid communication with an annular space extending around the actuator 128.

The cooling device 184 further comprises a cooling fluid source (not illustrated) intended to supply the fluid inlet 186 with cooling fluid.

The at least one force sensor 156 is configured to measure a support force generated by the stirring pin 28 on a substrate.

The guiding device 192 for the effector 40 and the stirring device 26 comprises:
a base 194 capable of being mounted, for example, on the at least one arm 208 of the robot 206;
at least one base 200 of the effector 40; and
at least one guiding bar 202.

The base 194 comprises, for example, two mounts 196 each defining a guide through-hole 198 extending substantially parallel to the longitudinal axis A-A′. The two guide through-holes 198 are aligned and are traversed by the at least one guiding bar 202.

The at least one mounting base 200 of the effector 40 is mounted on the at least one guiding bar 202.

The translation of the at least one guiding bar 202 parallel to the longitudinal axis A-A′ through the guide through-holes 198 causes the translation parallel to the longitudinal axis A-A′ of the effector 40.

The robot 206 comprises at least one articulated arm 208 and at least one motorization device 210 configured to move the at least one articulated arm 208.

The at least one articulated arm 208 carries the manufacturing system 24.

The at least one arm 208 is movable between a plurality of positions allowing the stirring pin 28 to be arranged precisely relative to the substrate of the manufactured object to be manufactured. Advantageously, the robot 206 is configured so that the position and actuation of the at least one arm 208 is controlled based on the support force measured by the at least one force sensor 156.

In the following, the operation of the installation 10 is described.

In the initial state, the feed system 12 supplies the manufacturing system 24 with drawn manufacturing material 1.

In particular, the feed system 12 rotates the drawn manufacturing material 1 around its neutral fiber.

Notably, the rotary unwinding device 14 rotates the spool 16 around the main rotation axis R1 and rotates the unwound drawn manufacturing material 1 around its neutral fiber.

For example, the guiding device 18 guides the unwound drawn manufacturing material 1 from the rotary unwinding device 14 to the manufacturing system 24. This guidance is preferably carried out without the unwound drawn manufacturing material 1 being discharged.

The drawn manufacturing material 1 then enters the effector 40.

In particular, the drawn manufacturing material 1 extends in the tubular passage 132 of the shaft 130 of the actuation mechanism 126 from the axial entry 42A of the conveying path 42 of the drawn manufacturing material 1.

The drawn manufacturing material 1 further extends in the axial passage 50 of the base 48 of the support 46 of the feed mechanism 44 as well as in the respective conical passages 88 of the first and second gripping members 80, 116.

The drawn manufacturing material 1 further extends in the axial passage 34 of the support 30 of the stirring device 26 to the stirring pin 28.

The drawn manufacturing material 1 is rotated around the longitudinal axis A-A′ (notably around its neutral fiber, since its neutral fiber is then coincident with the longitudinal axis A-A′) by the actuation mechanism 126.

The feed mechanism 44 then alternates between its first configuration and its second configuration to move the drawn manufacturing material 11 in translation along the longitudinal axis A-A′ in the feeding direction DA.

According to a variant of the first embodiment, the actuation mechanism 126 is configured to rotate the feed mechanism 44 and the stirring pin 28 around the longitudinal axis A-A′. In this variant, the first gripping device 60 and the second gripping device 100 each comprise an actuator allowing the feed mechanism 44 to be placed in the first configuration or in the second configuration.

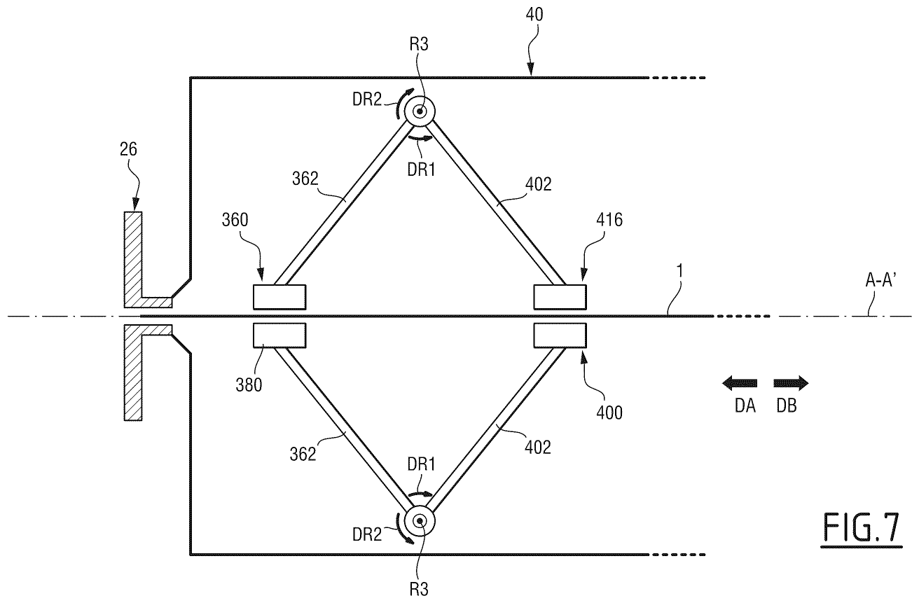

Referring to FIG. 7, a second embodiment of the present disclosure is described.

The second embodiment is identical to the first embodiment except for the following features.

The first gripping device 360 comprises at least two connecting rods 362 each articulated at a first end to at least one first gripping member 380 and at a second end to at least two connecting rods 402 of the second gripping device 400.

The second gripping device 400 comprises at least two connecting rods 402 each articulated at a first end to at least one second gripping member 416 and at a second end to the at least two connecting rods 362 of the first gripping device 360.

Each connecting rod 362 of the first gripping device 360 is articulated on a corresponding connecting rod 402 of the second gripping device 400 about a rotation axis R3 extending substantially perpendicular to the longitudinal axis A-A′.

The connecting rods 362 of the first gripping device 360 are notably articulated on the connecting rods 402 of the second gripping device 400 in a scissor-like manner.

Notably, the connecting rods and their articulations replace the racks of the first embodiment.

In particular, for each connecting rod 362, a rotation of said connecting rod 362 relative to the corresponding connecting rod 402 around the corresponding rotation axis R3 causes, in a first rotation direction DR1, the gripping members 380, 416 to move closer to each other and in a second rotation direction DR2 opposite to the first rotation direction DR1, a separation of the gripping members 380, 416 relative to each other.

The feed mechanism is notably:
in the first configuration when the rods 362 respectively rotate relative to the corresponding connecting rod 402 in the first rotation direction DR1 around the rotation axis R3;
in the second configuration when the connecting rods 362 respectively rotate relative to the connecting rod 402 in the second rotation direction DR2 around the rotation axis R3.

The rotation direction alternates between the first rotation direction DR1 and the second rotation direction DR2 to move the drawn manufacturing material 1 in translation along the longitudinal axis A-A′ in the feeding direction DA. The alternation of the rotation direction between the first rotation direction DR1 and the second rotation direction DR2 causes the alternation of the configuration of the feed mechanism between the first configuration and the second configuration.

In the second embodiment, the rotation of the assembly around the longitudinal axis A-A′ can be done with through bars similar to those used in the first embodiment. The rotation and translation motorization of the assembly can also be done with the same actuation device.

What is claimed is:

1. A manufacturing system for manufacturing a manufactured object by additive friction stir deposition from a drawn manufacturing material comprising:
a stirring device comprising a stirring pin intended to stir the drawn manufacturing material to manufacture the manufactured object;
an effector configured to rotate the stirring pin and to supply the stirring pin with drawn manufacturing material by translating the drawn manufacturing material along a longitudinal axis of the effector in a feeding direction;
the effector comprising an actuation device including a feed mechanism for feeding the drawn manufacturing material, the feed mechanism comprising a first gripping device and a second gripping device,
the feed mechanism being configurable in:
a) a first configuration wherein at least one first gripping member of the first gripping device grips the drawn manufacturing material and moves drawn manufacturing material in the feeding direction while at least one second gripping member of the second gripping device releases the drawn manufacturing material and moves in a direction opposite to the feeding direction;
b) a second configuration wherein the at least one second gripping member grips the drawn manufacturing material and moves drawn manufacturing material in the feeding direction while the at least one first gripping member releases the drawn manufacturing material and moves in the direction opposite to the feeding direction;
the feed mechanism being configured to alternate between the first configuration and the second configuration to move the drawn manufacturing material in translation along the longitudinal axis in the feeding direction.

2. The manufacturing system according to claim 1, wherein:
the at least one first gripping member is translatable along the longitudinal axis between a first proximal coordinate and a first distal coordinate;
the at least one second gripping member is translatable along the longitudinal axis between a second proximal coordinate and a second distal coordinate;
the first proximal coordinate being located downstream of the second distal coordinate according to the feeding direction.

3. The manufacturing system according to claim 1, wherein the at least one first and the at least one second gripping members are clamps configurable in:
a clamping configuration, wherein the clamps grip the drawn manufacturing material; and
a release configuration, wherein the clamps release the drawn manufacturing material;
the clamps being in:
the clamping configuration when the corresponding first or second gripping member is moved in the feeding direction; and
the release configuration when the corresponding first or second gripping member is moved in the direction opposite to the feeding direction.

4. The manufacturing system according to claim 3, wherein the clamps each comprise:
a base including a cylindrical skirt, the cylindrical skirt comprising a conical internal surface defining a conical passage extending substantially along the longitudinal axis and through which the drawn manufacturing material is intended to extend;
at least two clamping elements extending at least partly in the conical passage between the conical internal surface of the cylindrical skirt and the drawn manufacturing material, each clamping element comprising a conical external surface substantially complementary to the conical internal surface of the cylindrical skirt;
a constraint element capable of constraining the at least two clamping elements against the cylindrical skirt;
each clamp being such that:
in the clamping configuration, the constraint element constrains the at least two clamping elements against the cylindrical skirt so that each clamping element is constrained against the drawn manufacturing material to grip the drawn manufacturing material;
in the release configuration, the constraint element reduces the constraint on the at least two clamping elements so that each clamping element releases the drawn manufacturing material.

5. The manufacturing system according to claim 4, wherein the clamping elements comprise an internal surface intended to face the drawn manufacturing material and to cooperate with the drawn manufacturing material in the clamping configuration, the internal surface of each clamping element comprising teeth capable of gripping the drawn manufacturing material.

6. The manufacturing system according to claim 4, wherein the clamping elements are angularly distributed around the longitudinal axis.

7. The manufacturing system according to claim 1, wherein:
the first gripping device further includes:
a first distal flange on which the at least one first gripping member is mounted;
at least one first rack mounted on the first distal flange and extending substantially parallel to the longitudinal axis;
the second gripping device further includes:
a second distal flange on which the at least one second gripping member is mounted;
at least one second rack mounted on the second distal flange and extending substantially parallel to the longitudinal axis;
the feed mechanism further comprises at least one gear, each gear comprising teeth cooperating with teeth of the corresponding first rack and teeth of the corresponding second rack, each gear being rotatable about a rotation axis substantially perpendicular to a plane comprising the longitudinal axis;
the actuation device further comprises an actuation mechanism configurable between:
a first configuration wherein the actuation mechanism moves the at least one second rack in translation in the direction opposite to the feeding direction to simultaneously move:
the second gripping device in the direction opposite to the feeding direction;
the first gripping device in the feeding direction, by cooperation of the at least one second rack with the at least one first rack by means of the at least one gear;
a second configuration wherein the actuation mechanism moves the at least one second rack in translation in the feeding direction to simultaneously move:
the second gripping device in the feeding direction;
the first gripping device in the direction opposite to the feeding direction, by cooperation of the at least one second rack with the at least one first rack by means of the at least one gear;
the feed mechanism being:
in its first configuration when the actuation mechanism is in its first configuration;
in its second configuration when the actuation mechanism is in its second configuration;
the actuation mechanism being configured to alternate between its first and second configuration to move the drawn manufacturing material in translation along the longitudinal axis in the feeding direction.

8. The manufacturing system according to claim 7, wherein:
the first gripping device further includes a first proximal flange, the at least one first rack being further mounted on the first proximal flange;
the second gripping device further includes a second proximal flange, the at least one second rack being further mounted on the second proximal flange;
the first proximal flange comprising an annular body defining an axial passage traversed by the second gripping device.

9. The manufacturing system according to claim 7, wherein the feed mechanism comprises a support fixed in translation along the longitudinal axis, including a skirt extending substantially along the longitudinal axis, the skirt of the fixed support extending radially between the first gripping device and the second gripping device, each gear being mounted on the skirt of the fixed support.

10. The manufacturing system according to claim 1, wherein the actuation mechanism of the actuation device is further configured to rotate the feed mechanism and the stirring pin around the longitudinal axis.

11. The manufacturing system according to claim 10, wherein the actuation mechanism comprises:
an actuator;
a shaft extending substantially along the longitudinal axis and capable of being rotated around the longitudinal axis and translated along the longitudinal axis by the actuator;
a flange mounted on the shaft and extending substantially perpendicular to the longitudinal axis;
at least one rod designed to rotate together with the flange and extending substantially parallel to the longitudinal axis through the first gripping device, through the second gripping device, and at least partly through the stirring device;
the feed mechanism and the stirring pin being capable of being rotated around the longitudinal axis by the rotation of the at least one rod around the longitudinal axis.

12. The manufacturing system according to claim 11, wherein:
the first gripping device further includes:
a first distal flange on which the at least one first gripping member is mounted;
at least one first rack mounted on the first distal flange and extending substantially parallel to the longitudinal axis;
the second gripping device further includes:
a second distal flange on which the at least one second gripping member is mounted;
at least one second rack mounted on the second distal flange and extending substantially parallel to the longitudinal axis;
the feed mechanism further comprises at least one gear, each gear comprising teeth cooperating with teeth of the corresponding first rack and teeth of the corresponding second rack, each gear being rotatable about a rotation axis substantially perpendicular to a plane comprising the longitudinal axis;
the actuation device further comprises an actuation mechanism configurable between:
a first configuration wherein the actuation mechanism moves the at least one second rack in translation in the direction opposite to the feeding direction to simultaneously move:
the second gripping device in the direction opposite to the feeding direction;
the first gripping device in the feeding direction, by cooperation of the at least one second rack with the at least one first rack by means of the at least one gear;
a second configuration wherein the actuation mechanism moves the at least one second rack in translation in the feeding direction to simultaneously move:
the second gripping device in the feeding direction;
the first gripping device in the direction opposite to the feeding direction, by cooperation of the at least one second rack with the at least one first rack by means of the at least one gear;
the feed mechanism being:
in its first configuration when the actuation mechanism is in its first configuration;
in its second configuration when the actuation mechanism is in its second configuration;
the actuation mechanism being configured to alternate between its first and second configuration to move the drawn manufacturing material in translation along the longitudinal axis in the feeding direction, and
wherein the at least one second rack is mounted on the flange, the actuation mechanism being such that:
in the first configuration of the actuation mechanism, the actuator drives the at least one second rack in translation in the direction opposite to the feed direction by moving the shaft and the flange in translation in the direction opposite to the feed direction;
in the second configuration of the actuation mechanism, the actuator drives the at least one second rack in translation in the feed direction by moving the shaft and the flange in translation in the feed direction.

13. The manufacturing system according to claim 10, wherein the actuation mechanism is configured to drive the first and second gripping devices in rotation around the longitudinal axis, and wherein:
the drawn manufacturing material is configured to be driven in rotation around its neutral fiber by the at least one first gripping member in the first configuration of the feed mechanism;
the drawn manufacturing material is configured to be driven in rotation around its neutral fiber by the at least one second gripping member in the second configuration of the feed mechanism.

14. The manufacturing system according to claim 1, wherein the effector further comprises:
an external casing delimiting an internal space wherein the feed mechanism extends; and
a bearing extending between the feed mechanism and the external casing and configured to guide the feed mechanism in rotation relative to the external casing.

15. The manufacturing system according to claim 14, wherein the effector further comprises a bearing extending between the stirring device and the external casing and configured to guide the stirring device in rotation relative to the external casing.

16. The manufacturing system according to claim 1, wherein the effector further comprises at least one force sensor configured to measure a push force generated by the stirring pin on a substrate.

17. A manufacturing installation for manufacturing a manufactured object, comprising:
the manufacturing system according to claim 1;
a feed system configured to feed the manufacturing system with drawn manufacturing material;
the feed system being configured to drive the drawn manufacturing material in rotation around its neutral fiber.

18. The manufacturing installation according to claim 17, wherein the feed system comprises:
a spool of drawn manufacturing material;
a rotary unwinding device configured to unwind the drawn manufacturing material from the spool;
a guiding device for guiding the unwound drawn manufacturing material without being discharged from the rotary unwinding device to the manufacturing system, the rotary unwinding device being configured to drive the spool in rotation around a main rotation axis and to drive the unwound drawn manufacturing material in rotation around its neutral fiber.

19. The manufacturing installation according to claim 18, wherein a difference between a rotation speed of the spool generated by the feed system of the manufacturing installation and the rotation speed of the drawn manufacturing material generated by the effector is between 0.5 rpm and 5 rpm when the drawn manufacturing material is stirred by the manufacturing system.
